(19) United States
(12) Patent Application Publication
(10) Pub. No.: US 2010/0064870 A1
(43) Pub. Date: Mar. 18, 2010

(54) FLUID JET CUTTING SYSTEM WITH BED SLAT CAPS

(75) Inventor: Carl C. Olsen, Vashon, WA (US)

Correspondence Address: GRAYBEAL JACKSON LLP, 400 - 108TH AVENUE NE, SUITE 700, BELLEVUE, WA, 98004, US

(73) Assignee: OMAX CORPORATION, Kent, WA (US)

(21) Appl. No.: 12/233,004

(22) Filed: Sep. 18, 2008

(51) Int. Cl. B26F 3/00

(52) U.S. Cl. 83/177; 83/652

(57) ABSTRACT

A bed slat cap is configured to protect a bed slat in a fluid jet cutting system. A fluid jet cutting system includes a plurality of bed slats, at least some of the plurality of bed slats being protected by one or more corresponding bed slat caps. A bed slat cap may include a hardened material to protect the bed slat. A bed slat cap may include a material softer than the bed slaps to protect the bottom of a workpiece. A fluid jet bed slat may be constructed as a composite assembly including a support portion and one or more fluid jet impingement portions.

### BACKGROUND

Fluid jets are used in production cutting applications worldwide. Fluid jets are used to cut or drill holes in materials ranging from glass, stone, and metals, to plastics, paper, foam, and food. Fluid jet cutting generally operates using a high speed jet of fluid to erode a workpiece. The high speed fluid jet is generated by using a high pressure pump to deliver high pressure fluid to a nozzle, and then converting the high pressure to high velocity at the nozzle.

The fluid may be substantially pure water (typically referred to as a water jet system), or water carrying a grit such as garnet (typically referred to as an abrasive jet). Abrasive particles may be entrained in the fluid jet by adding them in a mixing tube just downstream from the nozzle orifice. Abrasive jet systems are typically used to cut harder materials such as stone, ceramics, or metals. In abrasive jet systems, it is the high velocity abrasive particles that perform the lion's share of material erosion, rather than the fluid itself.

Many fluid jet systems include computer numerical control of the cutting or drilling path through a workpiece. A controller receives computer instructions and controls the cutting path. According to one commonly used approach, the nozzle is supported by an actuator that is able to move the nozzle in at least two axes relative to the workpiece, and the workpiece sits on a stationary support, typically referred to as a bed. Five-axis actuators are not uncommon.

A workpiece support system typically includes a suspension system such as metal slats that support the workpiece, and a water pool below the slats to receive and absorb the kinetic energy of the fluid jet. Unfortunately, fluid jet bed slats, and especially abrasive jet bed slats, may be prone to erosion and are typically replaced on a relatively regular basis. Because abrasive jet bed slats may be replaced relatively frequently, they are typically made from inexpensive steel that may be prone to rusting.

### SUMMARY

According to an embodiment, a fluid jet system includes a plurality of workpiece support bed slats that include a slat cover or cap. The slat cap may act as a sacrificial member that reduces erosion of the bed slat it is coupled to. The slat cap may include one or more hard features to reduce erosion of the bed slat. The slat cap may be made from a material softer than the bed slat to reduce splashback against the bottom of the workpiece and/or reduce a safety hazard corresponding to sharp edges after erosion by the fluid jet. The slat cap may include one or more features to deflect the impinging fluid jet and reduce splashback against the bottom of the workpiece.

According to another embodiment; a cutting and/or machining system, such as a laser, electron beam, torch, or plasma cutter; may support a workpiece with bed slats that are protected with caps configured to reduce degradation of a weight-supporting portion.

According to an embodiment, a fluid jet slat cap includes a feature to couple to a fluid jet bed slat and a top surface to support a workpiece. The feature may include a groove configured to slip over the top of the bed slat. The fluid jet slat cap may include a feature to receive a hardened member such as a reinforcing bar. The fluid jet slat cap may include a reinforcing bar. The reinforcing bar may be oriented to deflect an impinging fluid jet in a non-vertical direction.

According to another embodiment, a fluid jet slat cap may be configured as a sacrificial member that is damaged by the fluid jet substantially in lieu of damage to the fluid jet bed slat.

According to another embodiment, a fluid jet slat cap may be configured to receive fluid jet impingement substantially without damage, such as by constructing the slat cap from a hardened material, from a self-healing material, or from an energy absorbing material.

According to another embodiment, a fluid jet bed slat may be configured as a composite apparatus including a support portion and a fluid jet impingement portion. The fluid jet impingement portion may be configured as a sacrificial member that is damaged by the fluid jet substantially in lieu of damage to the support portion. The fluid jet impingement portion may alternatively be configured to receive fluid jet impingement substantially without damage, such as by including a material configured to absorb or deflect the fluid jet energy while undergoing minimal erosion.

### BRIEF DESCRIPTION OF THE FIGURES

FIG. 1 is a diagram illustrating a fluid jet cutting system according to an embodiment.

FIG. 2 is an illustration showing degradation of bed slats by a fluid jet cutter.

FIG. 3 is a view of a group of fluid jet bed slats fitted with slat caps, according to an embodiment.

FIG. 4 is a cross-sectional view of a fluid jet bed slat cap, according to an embodiment.

FIG. 5 is a cross-sectional view of a composite fluid jet bed slat including a support portion and at least one fluid jet impingement portion, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or and other changes may be made without departing from the spirit or scope of the disclosure.

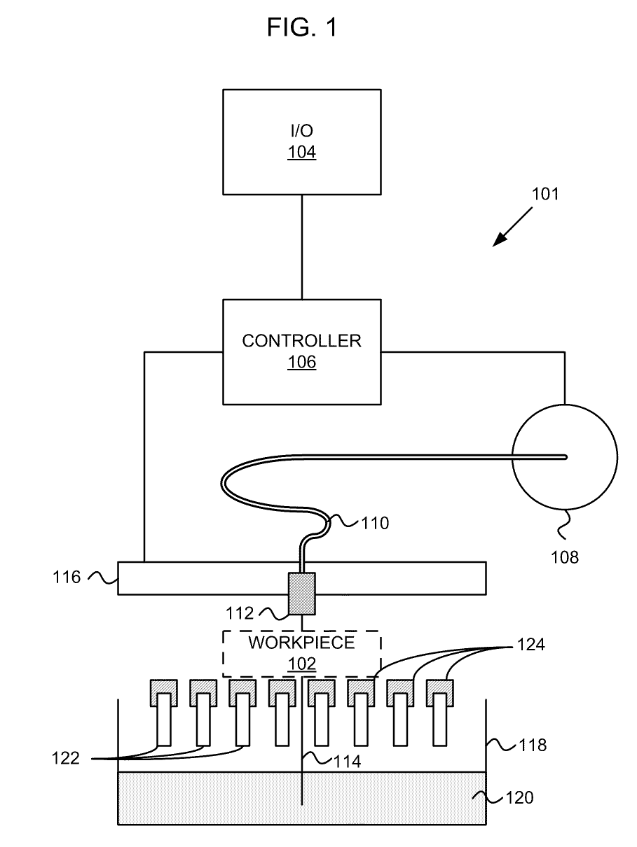

FIG. 1 is a diagram illustrating a fluid jet cutting system 101 configured to cut a workpiece 102, according to an embodiment. A computer interface 104 may be configured to receive computer instructions corresponding to a cutting path through the workpiece 102. A controller 106 may be configured to receive the computer instructions to drive the fluid jet cutting system 101. Alternatively, the cutting path may be produced by nozzle motion and/or workpiece motion driven by a different method, such as by hand guiding, for example.

The controller 106 may be operatively coupled to a high pressure pump 108. The pump 108 may optionally be controlled separately. The high pressure fluid pump 108 is configured to provide high pressure fluid through high pressure tubing 110 to a nozzle 112. The nozzle 112 receives the high pressure fluid and projects a fluid cutting jet 114. The fluid in the cutting jet 114 may include substantially pure water, or alternatively may include entrained abrasive particles such as garnet from an abrasive supply system (not shown).

The controller 106 is operatively coupled to drive an actuation system 116 configured to drive the position of the nozzle 112. Typically actuation systems 116 include at least X-Y drive. Some actuation systems additionally include Z-axis and tilt drive. The controller 106 drives the actuation system 116 to position the nozzle 112 to scan the fluid jet 114 across the workpiece 102 to make cuts. The workpiece is supported by a workpiece support system 118.

Because of the tendency for the cutting fluid jet 114 to cut through surfaces it may encounter, the workpiece support system typically includes a water table that contains a pool of water 120 into which the fluid jet 114 may penetrate. Frictional forces in the water 120 dissipate the kinetic energy of the fluid jet 114 and prevent the fluid jet 114 from cutting through the bottom of the water table.

The workpiece support system 118 may also include a plurality of bed slats 122 to support the workpiece 102 as the nozzle 112 and the fluid cutting jet 114 is moved relative to the workpiece 102. Bed slats 122 are typically made of mild steel or other metal. According to an embodiment, the bed slats 122 may be formed as 0.125 inch width pieces set on 1 inch centers, with a height adjusted to suit the workpiece load and/or a degradation allowance. In other embodiments, the slats may typically be spaced on 0.5 inch centers or 2 inch centers. The slats may alternatively be formed and placed according to other dimensions as determined by the user and/or fluid jet system or component manufacturer.

Typically, the fluid jet 114, especially when the fluid jet 114 includes an abrasive jet, may erode, cut, or otherwise degrade the bed slats 122 as it passes across the slats. Such degradation of the bed slats 122 typically gets worse over time as the fluid jet 114 passes over the bed slats 122 again and again.

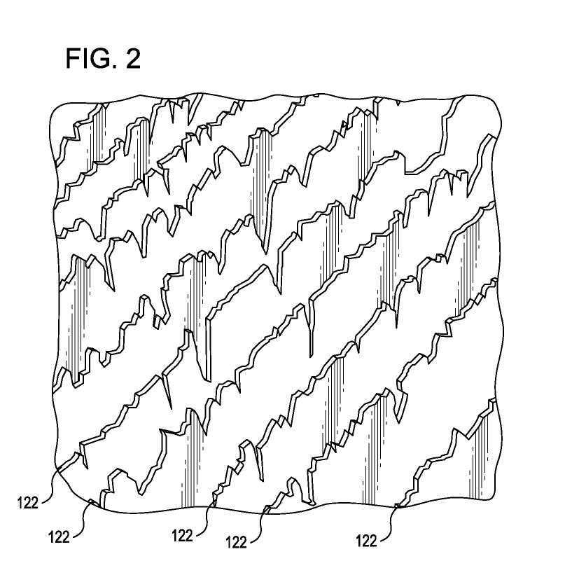

FIG. 2 is an illustration 201 showing degradation of bed slats 122 by a fluid jet cutter. Such degradation of the bed slats 122 may create a safety hazard arising from sharp edges. The degradation of the bed slats 122 may also reduce the accuracy of the height at which the workpiece 102 is held, which may affect cut accuracy. Ultimately, bed slats 122 may fail altogether from cut-through or as weakened bed slats 122 fail under the weight of a workpiece 102. Bed slats 122 may require relatively frequent replacement to avoid various failure modes.

Referring back to FIG. 1, another aspect of bed slats 122 is that they may tend to cause splash-back of the cutting jet 114 against the bottom surface of the workpiece 102. Such splash-back may cause degradation of the bottom surface of the workpiece owing to the relatively high remaining kinetic energy in the reflected cutting jet 114.

At least some of the plurality of slats 122 may be fitted with a corresponding plurality of covers or caps 124, according to embodiments. According to an embodiment, the slat caps 124 may be configured to reduce degradation of the bed slats 122 by the cutting jet 114. According to another embodiment, the slat caps 124 may be configured to reduce degradation of the workpiece 102 by splash-back of the cutting jet 114.

A fluid jet cutting system 101 may repeatedly cut along substantially identical cutting paths, for example corresponding to fixed shapes and/or shape locations in the workpiece 102. Repeated cutting along substantially identical cutting paths may tend to especially erode particular portions of the bed slats 122 that fall along the cutting paths. According to an embodiment, the bed slat caps 124 may include relatively short sections, at least in the areas most often traversed by cutting paths. The relatively short sections may be replaced or traded with other relatively short sections without necessitating change-out of entire bed slats 122 or entire bed slat caps 124 spanning large areas. According to an embodiment, a bed slat cap 124 may be formed in a length corresponding to one or more used mixing tubes from an abrasive jet nozzle, such mixing tubes typically being 3 inches to 4 inches long.

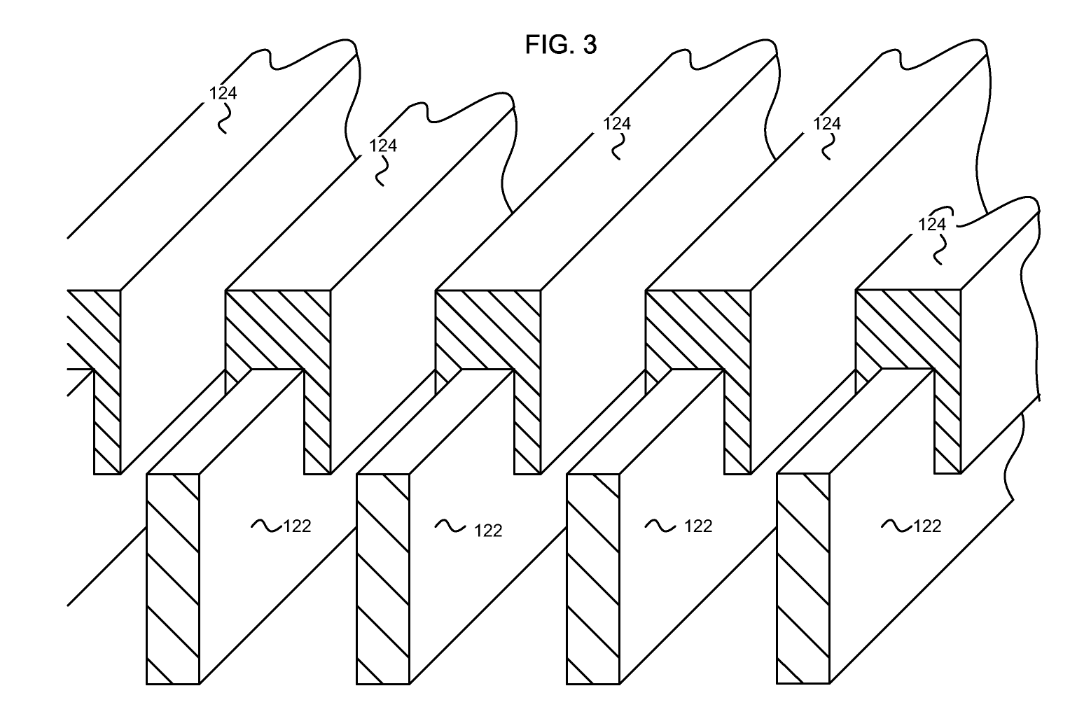

FIG. 3 is a partial perspective view of a group of fluid jet bed slats 122 fitted with slat caps 124, according to an embodiment. Each bed slat cover or bed slat cap 124 may be configured as a body configured to couple to one corresponding bed slat 122, as shown. The slat caps 124 may fit to the bed slats with a groove configured to receive the bed slats 122, as shown. The workpiece (not shown) may sit on and across the top surfaces of the slat caps 124. According to some embodiments, the slat caps 124 may be formed as elongated bodies having a length similar to the length of the bed slats 122. According to other embodiments, the slat caps 124 may be formed in lengths shorter than the length of the bed slats 122. For example, the bed slat caps 124 may be formed in a length corresponding to used mixing tubes from an abrasive jet nozzle

According to an alternative embodiment, the portions 122 may be configured as the support members and the portions 124 may be configured as fluid jet impingement portions of a composite fluid jet bed slat 122/124.

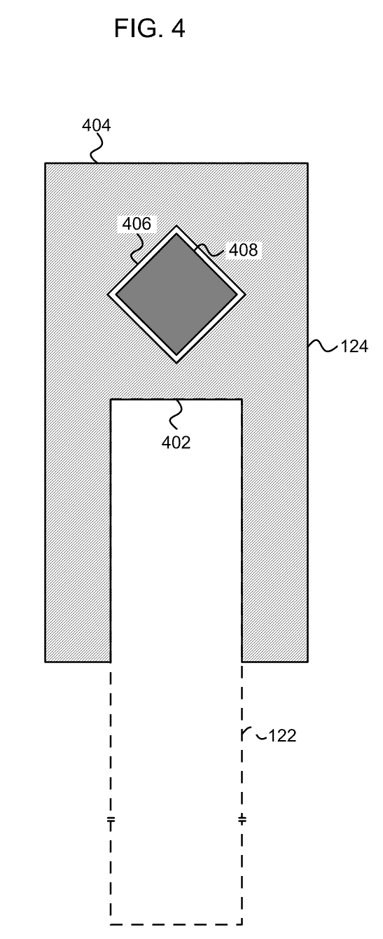

FIG. 4 is a cross-sectional view of a fluid jet bed slat cap 124, according to an embodiment. The fluid jet bed slat cap 124 may be configured as an elongated body (shown in perspective in FIG. 3 and in cross-section in FIG. 4) that has a feature 402 selected to couple to a fluid jet bed slat 122 and a top surface 404 configured to support a workpiece (not shown). For example, the feature 402 may include a groove formed with a width substantially equal to the width of the fluid jet bed slat 122, and a depth selected to maintain gravity coupling between the slat cap 124 and the slat 122. For example, the groove 402 may be about 0.125 inch width to fit on 0.125 inch width slats 122. The depth of the groove 402 may be about twice to about three times the groove width or more, such as 0.25 to 0.375 inch or more. The groove depth may be adjusted as a function of the thickness of the cap 124 above the slat 122, with greater rise corresponding to greater groove depth.

The width of the bed slat cap 124 is typically selected to substantially shield the top surface of the slat 122 and to avoid mechanical interference between adjoining or neighboring slat caps, and may be selected to provide sufficient mechanical strength of the protrusions defining the sides of the groove 402, while still allowing at least some clearance between neighboring slat caps. For example, the width of the bed slat cap 124 may be about 0.25 to about 0.375 inches or greater. The top surface 404 may include longitudinal chamfers or rounded edges (not shown) selected to relieve or reduce any burrs produced by the fluid jet. The length of the bed slat caps 124 may be made substantially equal to the exposed length of the bed slats 122. Alternatively, the length of the bed slat caps may be reduced to cover only a subset of the bed actually used for cutting, to allow selective replacement, and/or to allow rotation of the partial bed slat cap placement to counteract uneven wear. For example the length of the slat caps 124 may be made about equal to the length of a nozzle mixing tube. For example, the length of the slat caps 124 may be about 3-4 inches long.

According to an embodiment, the body of the bed slat cap 124 may be formed at least partially from a material softer than a fluid jet bed slat. For example, this may be used to reduce splash-back compared to a fluid jet bed slat alone. The bed slat cap 124 may be formed as a sacrificial cover configured to erode in lieu of slat erosion.

The bed slat cap 124 may be formed from a variety of materials. The bed slat cap 124 may include a molded, extruded, or machined metallic, polymeric, copolymeric, or hybrid material. For example, according to one embodiment, the bed slat cap 124 includes a machined high density polyethylene or a polypropylene. According to another embodiment, the bed slat cap may be formed from a material such as aluminum, brass, or other metal that is softer than steel. According to another embodiment, the bed slat cap may be formed from a material that is harder than mild steel such as a carbide-coated steel or a high carbon steel. The bed slat cap 124 may be formed as an extruded material such as a polyvinylchloride or other polymer. The body of the bed slat cap 124 may include a hybrid material such as a wood fiber impregnated or a glass-filled polymer or copolymer. Especially for embodiments where the bed slat cap 124 is molded, care should be taken to ensure that any mold draft in the groove 402 matches the corresponding shape of the slat 122.

According to an embodiment, the bed slat cap 124 may be formed as an elastomeric material such as a high-toughness elastomeric material configured to preferentially elastically deform under fluid jet pressure. For example, the bed slat cap 124 may be formed from an elastomeric polyurethane or chemically-toughened elastomeric polyurethane.

According to another embodiment, the elongated body of the bed slat cap 124 may be formed from wood. For example, the groove 402 may be formed by a wide-kerf table saw blade, two or more passes with a narrow-kerf table saw blade, a table saw dado blade, a router blade, a shaper blade, or other cutting tool depending on groove dimensions and/or production considerations.

The slat cap 124 may include a hard material configured to protect the bed slat 122 from the impinging fluid jet. Optionally, the elongated body of the slat cap 124 may include a cavity 406 between the groove 402 and the upper surface 404. The cavity 406 may be configured to receive a reinforcing bar 408. The slat cap 124 may include a reinforcing bar 408 configured to reduce degradation of the slat 122 by the fluid jet. For example, the reinforcing bar 408 may include tungsten carbide, titanium carbide, Kevlar, ceramic, or other material selected to resist erosion from the impinging fluid jet. The reinforcing bar 408 may be oriented to deflect the impinging cutting jet in a direction away from the bottom of the workpiece and/or away from the slat 122. In the example of FIG. 4, the reinforcing bar 408 is oriented to present slanted upper faces toward the fluid jet, which may help to deflect the impinging fluid jet in the horizontal direction, rather than vertically back toward the workpiece.

As mentioned above, the body of the slat cap 124 may include a cavity 406 configured to receive a reinforcing bar 408. Alternatively, the reinforcing bar 408 may be co-molded or co-extruded with the body of the slat cap 124.

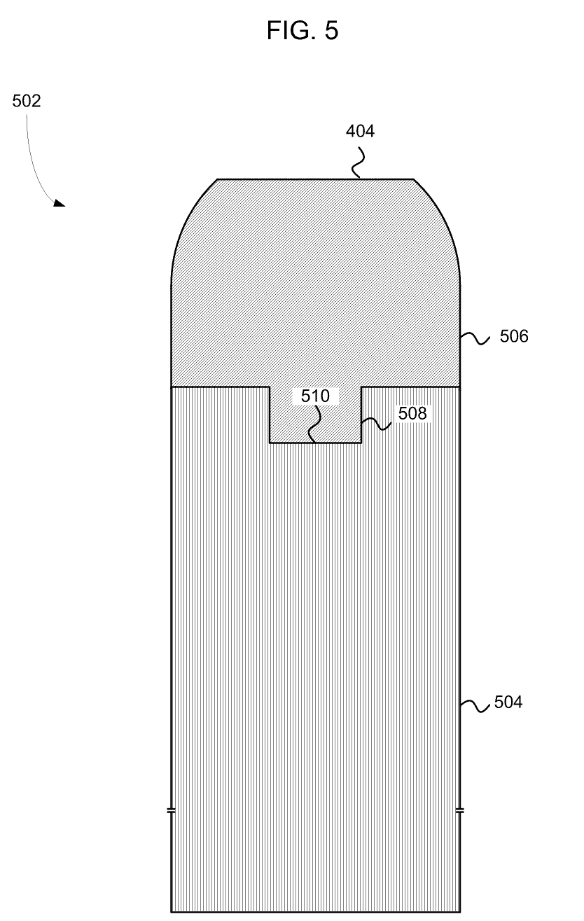

FIG. 5 is a cross-sectional view of a composite fluid jet bed slat 502, according to an embodiment. The composite fluid jet bed slat 502 may be configured as an elongated support portion 504 and one or more fluid jet impingement portions 506. The elongated support portion 504 may be optimized to support the weight and reactive force of the workpiece and one or more fluid jet impingement portions 506. The one or more fluid jet impingement portions 506 may be optimized to receive the impinging fluid jet (not shown).

The support portion 504 is typically configured to span a water pool (not shown). The at least one fluid jet impingement portion 506 may include one fluid jet impingement portion 506 made in a length corresponding to the support portion 504. Alternatively, the at least one fluid jet impingement portion 506 may be configured as a plurality of fluid jet impingement portions 506. Each of the plurality of fluid jet impingement portions 506 may be changed out as needed to accommodate erosion. For example, fluid jet impingement portions 506 positioned beneath a fluid jet cutting path may undergo erosion while fluid jet impingement portions 506 positioned elsewhere may undergo substantially no erosion. Providing a plurality of fluid jet impingement portions 506 along the length of the support portion 504 may allow economical replacement where needed.

The at least one fluid jet impingement portion 506 and the support portion 504 may include respective coupling features 508, 510 configured to maintain operative coupling between the portions. In the illustrative embodiment 502, for example, the support portion 504 includes a groove 510 in its upper surface and the fluid jet impingement portion 506 includes a corresponding ridge 508 in its lower surface. The walls of the ridge 508 and groove 510 may be vertical as illustrated or alternatively may be sloped, for example in a keyed configuration, or include additional grooves, ridges, radii, etc. configured to maintain coupling between the support portion 504 and at least one fluid jet impingement portion 506. Additionally or alternatively, adhesive, pressure-sensitive tape, or other fixing elements may be used to maintain contact between the at least one fluid jet impingement portion and the support portion 504.

While the coupling features 508, 510 are shown as different from the groove 402 in the embodiment of FIG. 4, other embodiments of composite fluid jet bed slats may be made as described above such as where the coupling feature 510 of the support portion 504 is substantially a rectangular top and the coupling feature 508 is similar to a groove 402 of FIG. 4.

According to some embodiments, the at least one fluid jet impingement portion 506 may be configured to resist damage from the impinging fluid jet. For example, the at least one fluid jet impingement portion 506 may be formed from an energy-absorbing polymer such as a polyurethane or chemically toughened polyurethane. Alternatively, the at least one fluid jet impingement portion 506 may resist damage through use of a self-healing polymer, such as an ultra high molecular weight polyethylene or polypropylene. Alternatively, the at least one fluid jet impingement portion may resist damage through use of a hard material such as a hard metal (e.g. high carbon steel, or an alloy including copper beryllium), a hard ceramic (e.g. tungsten carbide or titanium carbide), a hard metal coating (e.g. chrome), and/or a hard ceramic coating (e.g. diamond, tungsten carbide, or titanium carbide).

According to other embodiments, the at least one fluid jet impingement portion 506 may be configured as a sacrificial member. For example, the at least one fluid jet impingement portion 506 may include an ablation material, a polymer, a wood-filled hybrid polymer, a soft metal, or wood.

The at least one fluid jet impingement portion 506 may be constructed itself as a composite structure. For example, the at least one fluid jet impingement portion 506 may be constructed in a manner similar to the slat cap 124 of FIG. 4 and may include a hard material configured to protect the support portion 504 from the impinging fluid jet. Optionally, the fluid jet impingement portion 506 may include a cavity similar to the cavity 406 between the coupling feature 508 and the upper surface 404. The cavity may be configured to receive a reinforcing bar. The fluid jet impingement portion 506 may include a reinforcing bar configured to reduce or eliminate degradation of the support portion 504 by the fluid jet. For example, a reinforcing bar may include tungsten carbide, titanium carbide, Kevlar, ceramic, or other material selected to resist erosion from the impinging fluid jet.

According to an embodiment, the reinforcing bar may include a salvage material such as a used mixing tube from an abrasive jet nozzle. Used mixing tubes are typically very hard materials, typically are cylindrical and thus adapted to deflect an impinging fluid jet, and are relatively expensive and frequently replaced. One or more 3-4 inches mixing tubes may be inserted into the cavity between the coupling feature 508 and upper surface 404.

The reinforcing bar may be oriented to deflect the impinging cutting jet in a direction away from the bottom of the workpiece and/or away from the support portion 504. For example, in FIG. 4, the reinforcing bar 408 is oriented to present slanted upper faces toward the fluid jet, which may help to deflect the impinging fluid jet in the horizontal direction, rather than vertically back toward the workpiece.

While various aspects and embodiments have been disclosed herein, other aspects and embodiments are contemplated. The various aspects and embodiments disclosed herein are for purposes of illustration. The true scope and spirit is indicated according to the broadest valid meaning of the following claims.

What is claimed is:

1. A slat cap for a fluid jet cutter, comprising:
a body with a lower surface including a coupling configured to couple to a fluid jet bed slat; and
an upper surface configured to support a workpiece for cutting by the fluid jet.

2. The slat cap for a fluid jet cutter of claim 1, wherein the body is elongated and formed to have a length substantially corresponding to the length of a fluid jet bed slat.

3. The slat cap for a fluid jet cutter of claim 1, wherein the body is shorter than the length of a fluid jet bed slat.

4. The slat cap for a fluid jet cutter of claim 3, wherein the body has a length corresponding to the length of an abrasive jet mixing tube.

5. The slat cap for a fluid jet cutter of claim 3 wherein the body has a length corresponding to a whole number multiple of 3 or 4 inches.

6. The slat cap for a fluid jet cutter of claim 3 wherein the body is about 3-4 inches long.

7. The slat cap for a fluid jet cutter of claim 1, wherein the coupling includes a groove configures to fit over a fluid jet bed slat.

8. The slat cap for a fluid jet cutter of claim 1, wherein the upper surface of the body includes a material softer than a fluid jet bed slat configured to reduce splash-back compared to a fluid jet bed slat alone.

9. The slat cap for a fluid jet cutter of claim 8, wherein the body is formed from at least one polymer material.

10. The slat cap for a fluid jet cutter of claim 8, wherein the body is formed by molding.

11. The slat cap for a fluid jet cutter of claim 1, wherein the body is formed by extrusion.

12. The slat cap for a fluid jet cutter of claim 8, wherein the body includes wood fibers.

13. The slat cap for a fluid jet cutter of claim 8, wherein the body is formed from wood.

14. The slat cap for a fluid jet cutter of claim 1, wherein the body further includes a cavity between the coupling and the upper surface configured to receive a reinforcing bar.

15. The slat cap for a fluid jet cutter of claim 14, wherein the cavity is configured to receive a used abrasive jet mixing tube.

16. The slat cap for a fluid jet cutter of claim 1, wherein the body further includes a hard material configured to protect the slat from impinging fluid.

17. The slat cap for a fluid jet cutter of claim 16, wherein the body is formed substantially entirely from the hard material.

18. The slat cap for a fluid jet cutter of claim 16, wherein the hard material includes steel, an alloy including copper beryllium, chrome, tungsten carbide, titanium carbide, or ceramic.

19. The slat cap for a fluid jet cutter of claim 16, further comprising:
a reinforcing bar disposed between the top surface and the coupling in the body.

20. The slat cap for a fluid jet cutter of claim 19, wherein the reinforcing bar includes a mixing tube from an abrasive jet cutter nozzle.

21. The slat cap for a fluid jet cutter of claim 18, wherein the reinforcing bar and the body are formed by co-molding or co-extruding.

22. The slat cap for a fluid jet cutter of claim 16, wherein the hard material is configured to deflect an impinging jet away from the bottom of the workpiece.

23. The slat cap for a fluid jet cutter of claim 1, wherein the body is configured to substantially cover the top surface of the fluid jet bed slat.

24. A fluid jet cutting system, comprising:
a fluid pump configured to provide high pressure fluid;
a nozzle configured to receive the high pressure fluid and project a fluid cutting jet;
an actuation system configured to drive the position of the nozzle; and
a workpiece support system including a first plurality of slats to support a workpiece as the nozzle and the fluid cutting jet is moved relative to the workpiece, at least some of the plurality of slats being fitted with a second plurality of covers configured to reduce at least one of degradation of the slats by the cutting jet and degradation of the workpiece by splash-back of the cutting jet.

25. The fluid jet cutting system of claim 24, wherein the covers include covers formed from a relatively soft material including at least one selected from the group consisting of a polymer, a co-polymer, a hybrid material with wood fibers, a glass-filled polymer, a glass-filled copolymer, an elastomer, a toughened elastomer, polyethylene, high molecular weight polyethylene, polypropylene, polyvinyl chloride, polyurethane, chemically toughened polyurethane, and wood.

26. The fluid jet cutting system of claim 24, wherein each cover is configured to couple to one slat.

27. The fluid jet cutting system of claim 24, wherein each cover includes a hardened bar configured to reduce degradation of the slat.

28. The fluid jet cutting system of claim 27, wherein the hardened bar is oriented to deflect the impinging cutting jet in a direction away from the bottom of a workpiece.

29. The fluid jet cutting system of claim 24 wherein the covers include covers formed from a material harder than the slats.

30. The fluid jet cutting system of claim 24, wherein the first plurality and second plurality are substantially equal.

31. The fluid jet cutting system of claim 24, wherein the second plurality is at least twice the first plurality.

32. A composite fluid jet bed slat, comprising:
an elongated support portion configured to support the weight of a workpiece; and
at least one fluid jet impingement portion configured to receive an impinging fluid jet.

33. The composite fluid jet bed slat of claim 32, wherein the at least one fluid jet impingement portion includes a plurality of fluid jet impingement portions.

34. The composite fluid jet bed slat of claim 32, wherein the at least one fluid jet impingement portion includes a feature to maintain coupling to the elongated support portion.

35. The composite fluid jet bed slat of claim 32, wherein the at least one fluid jet impingement portion is configured to resist damage from the impinging fluid jet.

36. The composite fluid jet bed slat of claim 35, wherein the at least one fluid jet impingement portion includes at least one material selected from the group consisting of an energy-absorbing polymer, a self-healing polymer, a hard metal, a hard ceramic, a hard metal coating, and a hard ceramic coating.

37. The composite fluid jet bed slat of claim 32, wherein the at least one fluid jet impingement portion is configured as a sacrificial member.

38. The composite fluid jet bed slat of claim 37, wherein the at least one fluid jet impingement portion includes at least one material selected from the group consisting of an ablation material, a polymer, a wood-filled hybrid polymer, a soft metal, and wood.
